(19) United States
(12) Patent Application Publication
(10) Pub. No.: US 2023/0294450 A1
(43) Pub. Date: Sep. 21, 2023

(54) Wallpapering Aid and Method of Hanging Wallpaper

(71) Applicant: ATLANTIC INNOVATIONS INTERNATIONAL LIMITED, Preston, Lancashire (GB)

(72) Inventor: David Williams SWIFT, Los Angeles, CA (US)

(21) Appl. No.: 18/019,859

(22) PCT Filed: Aug. 5, 2021
(86) PCT No.: PCT/GB2021/052027

§ 371 Date: Feb. 6, 2023

(30) Foreign Application Priority Data
Aug. 6, 2020 (GB) 2012259.4

(51) Int. Cl. B44C 7/06; F16M 11/28

(52) U.S. Cl. CPC B44C 7/06; F16M 11/28

(57) ABSTRACT

There is disclosed a wallpapering aid comprising a base having a ground engaging portion, and a support. The support is configured to extend from the base and, in use, bear against a sheet of wallpaper hanging from a height above the support to cause a lower region of the sheet of wallpaper to hang offset horizontally from an upper region of the sheet of wallpaper. The wallpapering aid may be used to facilitate the preparation and fixing of the sheet of wallpaper to a wall.

The invention relates generally to wallpapering. More particularly, the invention relates to a wallpapering aid and to a method of hanging wallpaper.

### BACKGROUND

When hanging wallpaper it is conventional to fold a sheet of wallpaper in a concertina or similar fold, temporarily adhering sections of the sheet to one another, so that the sheet can fixed to an upper region of a wall, then unravelled in a controlled and repeated manner, as one proceeds to fix the paper to the wall in descending stages. This method is intended to prevent a lower region of the sheet of wallpaper hanging against the wall and becoming fixed inadvertently thereto, in an incorrect position, while an upper region of the sheet is correctly aligned and fixed to the wall. Holding the folded sheet of wallpaper, while positioning it relative to the wall and fixing it thereto, can be difficult and time consuming. If the wallpaper is allowed to unfold inadvertently it may fall against the wall and become fixed in an incorrect position, requiring careful peeling of the wallpaper from the wall to be repositioned.

Earlier pat. application FR 2496014 A1 discloses a wallpapering aid that is attachable to a stepladder. This known wallpapering aid comprises three tubes attachable to one another by first and second pairs of clamps. The first pair of clamps attaches a first tube the stepladder. The second pair of clamps attaches the first tube to a second tube, and the second tube to a third tube. In use, the second pair of clamps allows the tubes to be positioned relative to one another such that the third tube extends adjacent a wall in front of the stepladder, to act as a barrier between a sheet of wallpaper and the wall, and thus prevent the sheet of wall paper hanging against the wall. This is arrangement has been found to be cumbersome and difficult to use.

It is an object of embodiments of the invention to at least mitigate one or more problems associated with known arrangements.

### SUMMARY OF THE DISCLOSURE

According to a first aspect, there is provided a wallpapering aid comprising: a base; and a support configured to extend from the base and, in use, bear against a sheet of wallpaper hanging from a height above the support to cause a lower region of the sheet of wallpaper to hang offset horizontally from an upper region of the sheet of wallpaper. The wallpapering aid may improve the ease with which a sheet of wallpaper is fixed to a wall, and/or prepared to be fixed to the wall. The wallpapering aid may negate the need to fold a sheet of wallpaper to avoid it becoming fixed to the wall inadvertently, and thus improve the ease with which the sheet of wallpaper may be handled. The base may have a ground engaging portion. In developing the wallpapering aid, it was found to be advantageous that the wallpapering aid comprise a base having a ground engaging portion, as the arrangement allows the wallpapering aid to be freestanding.

The wallpapering aid may further comprise first and second connecting portions cooperable with one another to releasably connect the base and the support to one another. The first and second connecting portions may be cooperable with one another such that the support extends from the base selectively in a first configuration, in which the support extends from the base furthest in a first direction, and a second configuration, in which the support extends from the base furthest in a second direction opposite the first direction. The first and second directions may be horizontal, or at least substantially horizontal. In certain embodiments, the first and second connecting portions may be cooperable with one another such that the support extends from the base in the first and second configurations only. In developing the wallpapering aid, it was found to be advantageous that the support extends from the base generally on opposing sides thereof selectively, to allow a user to work on the opposing sides selectively. In particular, this facilities hanging wallpaper in opposing corners of a room, as well as around obstacles on a wall, for example doors, windows and electrical fittings. Moreover, in developing the wallpapering aid, it was found to be advantageous that the first and second connecting portions be cooperable with one another such that the support extends from the base in a limited number of predetermined configurations to allow for quick and easy positioning of the support relative to the base.

In certain embodiments, the first and second connecting portions may be cooperable with one another in that the first connecting portion has a hole and the second connecting portion has a peg (or pin) receivable in the hole. The hole may be an open channel extending through the first connecting portion and the peg may be receivable in the channel via an open end thereof such that the peg extends through a mouth of the channel. The channel may have a substantially acute trapezoidal cross-section, the mouth of the channel being a shortest side of two parallel sides of the cross-section of the channel. The peg may have a substantially acute trapezoidal cross-section and may be receivable in the channel such that a longest of two parallel sides of the cross-section of the peg is disposed inside the channel and a shorter side of the two parallel sides of the cross-section of the peg is disposed outside the channel.

The peg may have a plurality of spaced apart peg portions. The first and second connecting portions may be cooperable with one another in that one or more of peg portions are receivable in the hole selectively. One or more of peg portions may be receivable in the hole selectively such that the support extends from the base selectively in the first and second configurations. One or more of peg portions may be receivable in the hole selectively such that the support extends from the base selectively in the first and second configurations, and a third configuration, in which the support hangs from the base in a vertical direction.

The peg may have rotational symmetry of order two such that the peg is receivable in the hole selectively in a first orientation and a second orientation and the support extends from the base in the first and second configurations, respectively. The peg may be receivable in the hole in the first and second orientations only. The peg may be retained in the hole by gravity, and/or by friction.

In certain embodiments, the first and second connecting portions may be cooperable in that together they provide a push fit connection. The base may comprise the first connecting portion and the support may comprise the second connecting portion, or vice versa.

A distance between the ground engaging portion of the base and the support may be variable. To this end, the base may comprise a telescopic portion configured to vary the distance between the ground engaging portion of the base and the support. Additionally, or alternatively, the base may comprise a plurality of discrete parts connectable, including releasably connectable, to one another. A first part of the plurality of discrete parts may the ground engaging portion and a second part of the plurality of discrete parts may be the telescopic portion. The plurality of discrete parts may additionally include a third part, fourth part, and so on. Leaving aside one or more of the plurality of discrete parts when assembling the wallpapering aid may allow the distance between the ground engaging portion of the base and the support to be varied. Additionally, or alternatively, the base may comprise a plurality of connecting portions according to either of the first and second connecting portions, each of the plurality of connecting portions being configured such that, in use, the support extends from the base selectively at a first height above the ground when connected to one of the plurality of connecting portions and at a second height above the ground, lower than the first height, when connected to another of the plurality of connecting portions.

In certain embodiments, the support may comprise a plurality of spaced apart first projections to, in use, bear against the sheet of wallpaper. In developing the wallpapering aid, it was found to be advantageous to provide such first projections, to inhibit removal of wallpapering adhesive applied to the sheet of wallpaper. Additionally, or alternatively the support may comprise a plurality of spaced apart second projections to, in use, contact a wall adjacent the wallpapering aid. In developing the wallpapering aid, it was found to be advantageous to provide such second projections, to facilitate achieving an optimum position of the support relative the wall.

According to a second aspect, there is provided a method of hanging wallpaper comprising: providing a wallpapering aid adjacent a wall to be wallpapered, the wallpapering aid comprising: a base having a ground engaging portion; and a support configured to extend from the base; fixing an upper edge of a sheet of wallpaper to a wall at a height above the support while the support bears against the sheet of wallpaper to cause a lower region of the sheet of wallpaper to hang offset horizontally from an upper region of the sheet of wallpaper.

The method may further comprise releasably connecting the base and the support to one another selectively such that the support extends from the base in a first configuration, in which the support extends from the base furthest in a first direction, and a second configuration, in which the support extends from the base furthest in a second direction opposite the first direction. The method may further comprise providing the wallpapering aid adjacent a wall such the support contacts the wall.

### BRIEF DESCRIPTION OF THE DRAWINGS

Embodiments of the invention will now be described, by way of example only, with reference to the accompanying figures, in which:

FIG. 1 is a perspective view of an exemplary wallpapering aid comprising a base and a support extending from the base in a first configuration;

FIG. 2 is a perspective view of a first connecting portion of the wallpapering aid shown in FIG. 1;

FIG. 3 is a perspective view of a second connecting portion of the wallpapering aid shown in FIG. 1;

FIG. 4 is a further perspective view of the wallpapering aid shown in FIG. 1, showing the base in an extended state;

FIG. 5 is a further perspective view of the wallpapering aid shown in FIG. 1, showing the base in an retracted state;

FIG. 6 is a perspective view of the support of the wallpapering aid shown in FIG. 1;

FIG. 7 is a perspective view of the wallpapering aid shown in FIG. 1, the wallpapering aid shown in use;

FIG. 8 is a perspective partial view of a further exemplary wallpapering aid comprising a base and a support extending from the base in a first configuration;

FIG. 9 is a further perspective partial view of the wallpapering aid shown in FIG. 8, showing the support in a third configuration; and

FIG. 10 is partial view of a further exemplary wallpapering aid showing a base of the wallpapering aid only.

### DETAILED DESCRIPTION

While the present invention relates to a wallpapering aid, it will be understood that although described as intended for use in hanging wallpaper, the wallpapering aid may be used in hanging other wall coverings and the like.

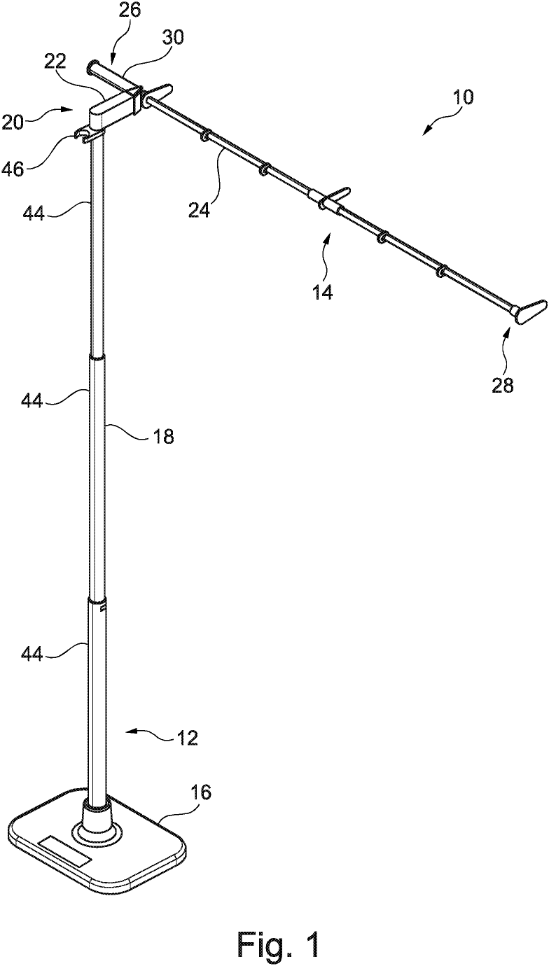

FIG. 1 shows an example of a wallpapering aid 10. The wallpapering aid 10 has a base 12 and a support 14. The support 14 is configured to extend from the base 12 and, in use, bear against a sheet of wallpaper P (see FIG. 7) hanging from a height above the support 14 to cause a lower region of the sheet of wallpaper P to hang offset horizontally from an upper region of the sheet of wallpaper P. In the example, the base 12 has a ground engaging portion 16 and a riser portion 18. The ground engaging portion 16 and the riser portion 18 are discrete parts, connectable to one another. The connection may be made by any suitable means, including the ground engaging portion 16 and the riser portion 18 having cooperating parts of a bayonet mount or connection, respectively. However, variations are contemplated, for example the ground engaging portion 16 and the riser portion 18 may be a single part. In the example, the riser portion 18 extends vertically from the ground engaging portion 16 and terminates having a free end 20. Although, alternatively, the riser portion 18 may extend from the ground engaging portion 16 offset by an angle from vertical. The base 12 comprises a first connecting portion 22. In the example, the first connecting portion 22 is a discrete part in the form of a cap connectable to the free end 20 of the riser portion 18. However, it is contemplated that the first connecting portion 22 may be integral to the base 12, for example integral to the riser portion 18. The support 14 has an elongate portion or beam 24, which has first and second ends 26, 28. The support 14 comprises a second connecting portion 30. In the example, the second connecting portion 30 is a discrete part in the form of a handle connectable to the first end 26 of the beam 24. Again, variations are contemplated, for example the beam 24 and the second connecting portion 20 may be a single part.

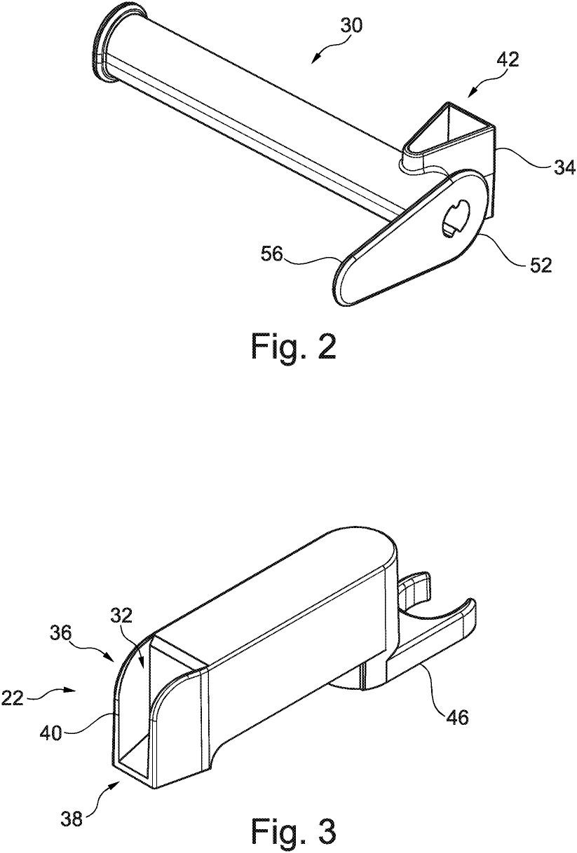

FIGS. 2 and 3 show in better detail the first and second connecting portions 22, 30, which, in the example, are cooperable with one another to releasably connect the base 12 and the support 14 to one another. To this end, in the example, the first connecting portion 22 has a channel (hole) 32 and the second connecting portion 30 has a peg 34 receivable in the channel 32. The first connecting portion 22 extends horizontally from the riser portion 18 to provide the channel 32 offset horizontally from the riser portion 18. The channel 32 extends vertically and has an open end 36, which is an upper end, and a closed end 38, which is a lower end. The channel 32 is an open channel, having a mouth 40 facing outwardly from the riser portion 18, and extending along the channel 32 from the open end 36 to the closed end 38. The peg 34 extends perpendicularly to the beam 24 and terminates having a free end 42, and is shaped to complement a shape of the channel 32. In the example, the channel 32 has a substantially acute trapezoidal cross-section, the mouth 40 forming a shortest side of two parallel sides of the cross-section of the channel 32, and the peg 34 has a substantially acute trapezoidal cross-section also, the free end 42 of the peg 34 forming a longest of two parallel sides of the cross-section of the peg 34. In the example, the peg 34 is slidable vertically into the channel 32 to extend horizontally through the mouth 40, such that the longest side of the parallel sides of the cross-section of the peg 34 is inside the channel 32 and the shorter side of the parallel sides of the cross-section of the peg 34 is outside the channel 32. The peg 34 is retained in the channel 32 due to the closed end 38 and the complementary cross-sections, as the longest side the parallel sides of the cross-section of the peg 34 is longer than the shortest side of the two parallel sides of the cross-section of the channel 32. Variations are contemplated, and it will be understood that many other shapes of the cross-sections of the channel 32 and the peg 34 are suitable. The shapes of the cross-sections of the channel 32 and peg 34 need not be the same. Generally, the peg 34 and the channel 32 may be shaped respectively such that the peg 34 is prevented, or at least inhibited, from being introduced into or removed from the channel 32 via the mouth 40.

Referring again to FIG. 1, when received in the channel 32, the peg 34 cannot rotate relative thereto such that the position of the support 14 is fixed relative to the base 12 and the support 14 extends from the base 12 in a first configuration, in which the support 14 extends from the base 12 furthest in a first direction. As such, in the first configuration, the support 14 extends from the base 12 generally on a first side of the wallpapering aid 10. As shown in FIG. 1, the first direction is horizontal and perpendicular to the base 12. In the example, the peg 32 has rotational symmetry of order two such that the peg 34 is receivable in the channel 32 in a first orientation and a second orientation, the second orientation being offset from the first orientation by 180°. The first orientation of the peg 34 corresponds to the first configuration of the of the support 14. The second orientation of the peg 34 corresponds to a second configuration of the support 14, in which the support 14 extends from the base 12 furthest in a second direction opposite the first direction. In the second configuration, the support 14 extends from the base 12 generally on a second side of the wallpapering aid 10. As such, the peg 34 is receivable in the channel 32 selectively in either of the first and second orientations, to connect the first and second connecting portions 22, 30 to one another such that that the support 14 extends from the base 12 selectively in the first and second configurations. In the example, the channel 32 and the peg 34 are sized and shaped respectively such that the peg 34 is receivable in the channel 32 in the first and second orientations only. Consequently, the first and second connecting portions 22, 30 are cooperable with one another such that the support 14 extends from the base 12 selectively in the first and second configurations only.

However, variations are contemplated, for example the peg 34 may be receivable in the channel 32 in a single orientation only and the support 14 is movable relative to the base 12, at least to move the support between the first and second configurations, for example by virtue of a pivot or the like. Alternatively, the peg 34 may be rotatable in the channel 32, at least to move the support 14 between the first and second configurations.

The peg 34 is retained in the channel 32 by gravity. Thus, first and second connecting portions 22, 30 are cooperable with one another to releasably connect the base 12 and the support 14 to one another in a toolless manner; no fasteners, clamps or the like are required to make the connection. Additionally, or alternatively, the channel 32 and the peg 34 may be sized respectively such that together they provide a push fit connection. Additionally, or alternatively, the channel 32 and/or the peg 34 may be configured such that they provide a snap fit connection, in which case a release mechanism (not shown) may be provided to remove the peg 34 from the channel 32.

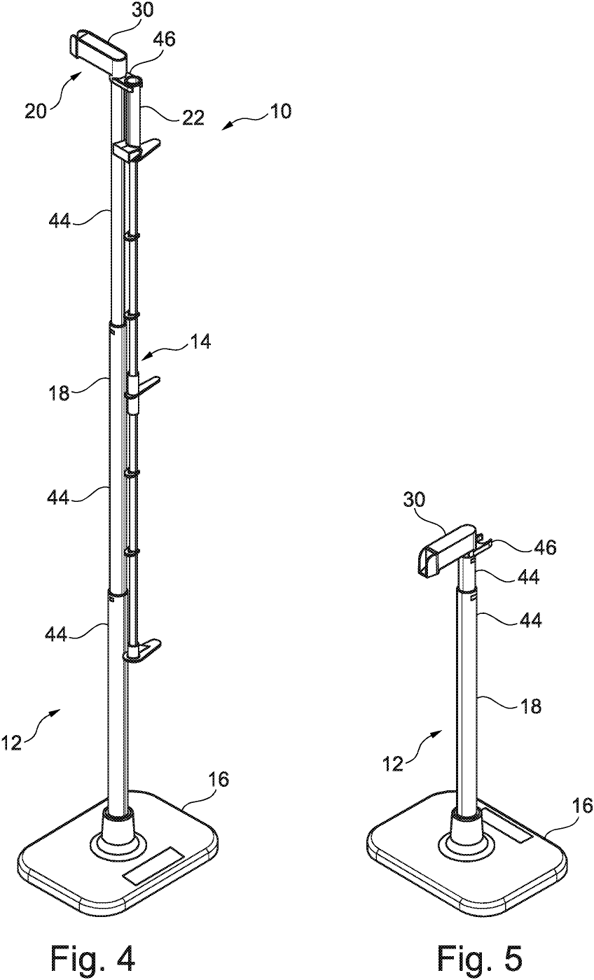

Turning now to FIGS. 4 and 5, a distance between the ground engaging portion 16 of the base 12 and the support 14 is variable, to adjust a height at which the support 14 extends above the ground. To this end, in the example, the riser portion 18 is telescopic. In FIG. 4, the riser portion 18 is fully extended, providing a maximum distance between the ground engaging portion 16 and the support 14. In FIG. 5, the riser portion 18 is retracted, providing a minimum distance between the ground engaging portion 16 and the support 14. Additionally, the riser portion 18 may be partially extended to provide one or more intermediate distances between the maximum and minimum distances. In the example, the riser portion 18 has three telescoping tubes 44, the positions of which relative to one another when fully expanded being fixed by telescopic tube locks 46. However, any number of the telescopic tubes 44 may be provided, and friction acting between the telescopic tubes 44 may fix their position relative to one another. The telescopic tubes 44 are discrete parts connectable to one another. Variations are contemplated, for example the riser portion 18 may a comprise a plurality of discrete parts connectable to one another that are not telescopic, and the distance between the ground engaging portion 16 of the base 12 and the support 14 may variable by connecting all or a limited number of the discrete parts selectively. The connection may be made by any suitable means, including the discrete parts having cooperating threaded parts, respectively, or being configured to provide a push fit connection. FIG. 4 also shows the support 14 connected to the base 12 via a hanger or clip 46, and hanging from the base 12 parallel to the riser portion 18. The clip 46 allows the support 14 to be conveniently stored on the base 12, without extending in either of the first and second configurations. As shown in FIG. 3, the clip 46 is formed integral to the first connecting portion 22 to extend from the riser portion 18 on an opposite side thereof relative to the channel 32.

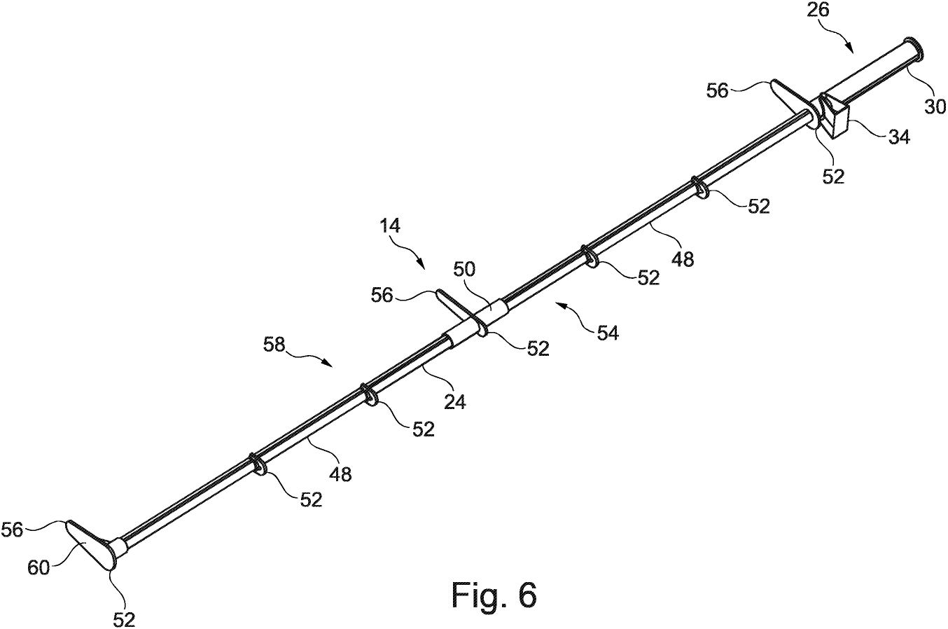

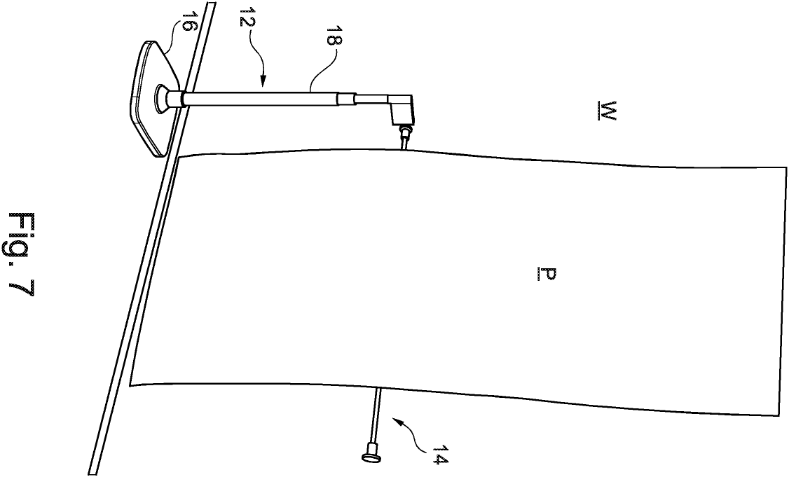

FIG. 6 shows the support 14 in isolation. As above, the second connecting portion 30 is a discrete part in the form of a handle connectable to the first end 26 of the beam 24. In the example, the beam 24 comprises two discrete beam portions 48 connectable to one another by an intermediate portion 50, although the beam 24 may be a single part. The beam portions 48 may be the same or different lengths. The support 14 comprises a plurality of spaced apart first projections 52 extending from a first side 54 of the beam 24. The first projections 52 are configured to, in use, bear against the sheet of wallpaper P. The spacing between each of the first projections 52 may be at least 65 mm and/or no more than 155 mm. Each of the first projections 52 may extend from the beam 24 by at least 6 mm and/or no more than 12 mm. The first projections 52 may have thickness of at least 1 mm and/or no more than 10 mm, and may be between 2 and 3 mm. The support 14 further comprises a plurality of spaced apart second projections 56 extending from a second side 58 of the beam 24, the second side 58 being opposite the first side 54 of the beam 24. The second projections 56 are configured to, in use, contact the wall. The spacing between each of the second projections 56 may be at least half the total length of the beam 24 and/or no more than the full length of the beam 24. The second projections 56 may have thickness of at least 1 mm and/or no more than 10 mm, and may be between 2 and 3 mm. Each of the second projections 56 may extend from the beam 24 by at least 40 mm and/or no more than 55 mm. In the example, three of the first projections 52 and three of the second projections 56 are single parts, each part comprising one of the first projections 52 and one of second projections 56. As shown in FIG. 2, the second connecting portion 30 is one such part, comprising one of the first projections 52 and one of second projections 56. The intermediate portion 50 also comprises one of the first projections 52 and one of second projections 56. An end cap 60 connectable to the second end 28 of the beam 24 comprises one of the first projections 52 and one of second projections 56. Four of the first projections 52 are discrete partially disc-like parts connectable to the beam 24.

FIG. 7 shows the wallpapering aid 10 in use, having the support 14 in the first configuration and the riser portion 18 partially extended. In use, a user positions the wallpapering aid 10 adjacent a wall W to be wallpapered. The wallpapering aid 10 is positioned such that support 14 contacts the wall W, by virtue of the second projections 56. The second projections 56 may establish an optimum distance between the beam 24 the wall W, and thus may inhibit the sheet of wallpaper P sagging toward the wall and becoming inadvertently fixed thereto. The user prepares the sheet of wallpaper P to be fixed to the wall W, before aligning an upper edge of the sheet of wallpaper P at a height above the support 14 and fixing the upper edge to the wall W. The support 14 acts as a barrier between the sheet of wallpaper P and the wall, as the support 14 bears against the sheet of wallpaper P hanging from a above the support 14 causing the sheet of wallpaper P to hang offset horizontally from an upper region of the sheet of wallpaper P. In the example, it is first projections 52 of the support 14 that bear against the sheet of wallpaper P. As will be understood, the first projections 52 reduce an area of the wallpaper P that is in contact with the support 14, which may inhibit the support 14 becoming fixed to the sheet of wallpaper P and/or may reducing the amount of adhesive that may be removed or moved. The second projections 56 may have the same effect if so-called “paste-to-wall” wallpaper adhesive is used. Once the uppermost edge of sheet of wallpaper P is fixed to the wall W, and with the support 14 bearing against the sheet of wallpaper P, the user’s hands are free to continue to fix the paper to the wall W in descending stages, and smooth the sheet of wallpaper P to remove creases and bubbles. The wallpapering aid 10 may allow the sheet of wallpaper P to be easily fixed to the wall W, without the need for the sheet of wallpaper P to be folded in a concertina or similar. The wallpapering aid 10 may allow the user to fix the upper edge of the sheet of wallpaper P to the wall W, thereafter being able to release both hands, without the concern of the folded or unfolded sheet of wallpaper P unravelling and fixing to the wall W in an incorrect position and/or with creases and/or bubbles. The user is free collect tools, and/or reposition the wallpapering aid 10. The wallpapering aid 10 may improve the safety of working on a ladder to fix the sheet of wallpaper P to the wall W. The support 14 may be quickly and easily released from the base 12, to allow the user to fix the lower region of the sheet of wallpaper P to the wall W. The support 14 may be released from the base 12 with one hand and/or without the need for tools.

As above, the first connecting portion 22 extends horizontally from the riser portion 18 to provide the channel 32 offset horizontally from the riser portion 18. The connecting portion 22 extends a sufficient distance from the riser portion 18 such that there is sufficient clearance between the wall W and the base 12, e.g. the ground engaging portion 16, to inhibit skirting boards, carpet grippers, cable hiders and the like preventing the base from sitting flat on the floor and from preventing the support/projections 56 from contacting the wall W.

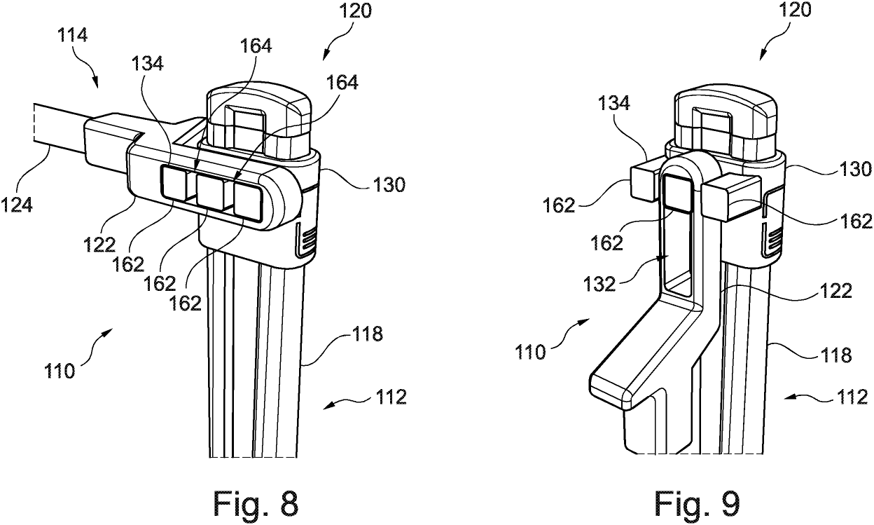

FIG. 8 shows a further example of a wallpapering aid 110 (shown only partially), in which features the same as, or at least similar to, those described above are denoted with reference numerals offset by a factor of 100. In the example, the support 114 comprises the first connecting portion 122 having a hole 132 extending therethrough. The base 112 comprises the second connecting portion 130 having the peg 134 connected to the riser portion 118 of the base 112. The peg 134 has three spaced apart peg portions 162, between which extend gaps 164. The peg 134 may be received in the hole 132 such that one or more of the peg portions 162 is inside the hole 132. As in the previously described example, the peg 134 has rotational symmetry of order two such that the peg 134 is receivable in the hole 132 in a first orientation and a second orientation, the second orientation being offset from the first orientation by 180°. As such, the peg 134 is receivable in the hole 132 selectively in either of the first and second orientations, to connect the first and second connecting portions 122, 130 to one another, such that that the support 114 extends from the base 112 selectively in first and second configurations, respectively, as in the previously described example. In the example shown in FIG. 8, all three of the peg portions 162 are inside the hole 132 when the peg 134 is received in the hole 132, such that the support 114 extends from the base 112 in either of the first and second configurations, although this need not be the case. In the example, the peg 134 is receivable in the hole 132 in a third orientation, the third orientation being offset from each of the first and second orientations by 90°. FIG. 9 shows the peg 134 received in the hole 132 in the third orientation, in which only one of the peg portions 162 is inside the hole 132 and the first connecting portion 122 necessarily extends through the gaps 164. The third orientation corresponds to a third configuration in which the support 114 extends selectively from the base 112. In the third configuration the support 114 hangs from the base 112 parallel to the riser portion 118. The third configuration allows the support 114 to be conveniently stored on the base 112, without extending in either of the first and second configurations. While the example shows three peg portions 162, the peg 134 may have any number of peg portions 162. In the example, the second connecting portion 130 is configured to connect to the riser portion 118 such that it is slidable along the riser portion 118 to vary a distance between a ground engaging portion (not shown) of the base 112 and the support 114, to adjust a height at which the support 114 extends above the ground.

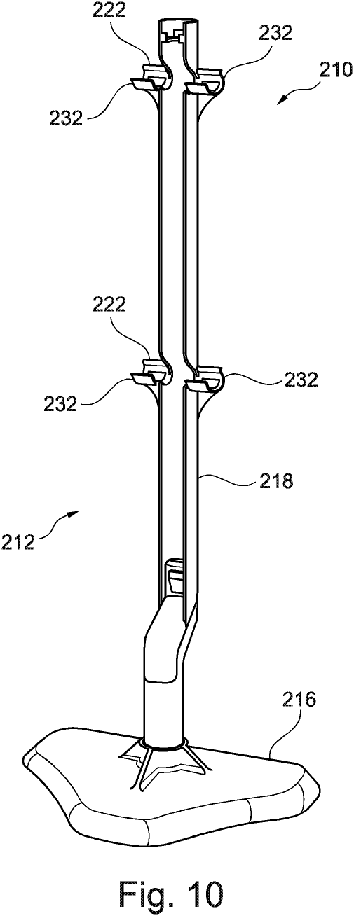

FIG. 10 shows a further example of a wallpapering aid 210, in which features the same as, or at least similar to, those described above are denoted with reference numerals offset by a further factor of 100. In the example, the base 212 comprises a pair of spaced apart first connecting portions 222, each of the pair of first connecting portions 222 being configured such that, in use, the support (not shown) extends from the base 212 at a first height above the ground when connected to one of the pair of first connecting portions 222 and at a second height above the ground, lower than the first height, when connected to the other of the pair of first connecting portions 222. In the example, each of the first connecting portions 222 comprises a pair of channels 232 in which the beam of the support is receivable to connect the first and second connection portions to one another. As such, the beam, or a region thereof, may provide the second connecting portion. The channels 232 may be resiliently deformable such that they deform to allow receipt of the beam and to exhibit a gripping force, due to their resiliency, to retain the beam therein.

The invention is not restricted to the details of the illustrated examples. For example, with reference to the first described example, the channel 32 may extend horizontally and the closed end 38 may be a second open end of the channel 32, and the peg 34 may be receivable in the channel 32 via either open end thereof. The first connecting portion 22 may have the peg 34 and the second connecting portion 30 may have the channel 32. The peg 32 may have rotational symmetry of order four, such that the peg 32 is receivable in the channel in the first and second orientations, and additionally in third and fourth orientations. To this end, the peg 32 may be frustrum shaped. The terms “hole” and “channel” may be used in interchangeably, and “hole” will be understood to encompass “channel”. The third orientation may corresponding to a third configuration of the support 14, 114 in which the support 14, 114 hangs from the base 12, 112, 212 in a vertical direction. Generally, the base 12, 112, 212 may not include the ground engaging portion 16,216 and/or the riser portion 18, 118, 216. The base 12, 112, 212 may be configured to attach to another article, for example a stepladder, and/or may comprise multiple discrete parts connectable to one another. The base 12, 112, 212 may be solid, hollow, fillable with a material, for example water or sand, or may be provided as a frame. The base 12, 112, 212 may have wheels. The base 12, 112, 212 may have feet. The feet may be configured to level the base 12, 112, 212. The hole 32, 132, 232 may be a blind hole or a through hole. The wallpapering aid 10, 110, 210 may comprise plurality of spaced apart connecting portions, each according to either of the first connecting portion 22, 122, 222 and the second connecting portion 30, 130, 230, to adjust a height at which the support 114 extends above the ground, e.g. to vary the distance between the ground engaging portion 16, 216 of the base 12, 212 and the support 14, 114. Two or more beam portions 48 may be used selectively, to vary a length of the beam 24, i.e. to vary a length of the support 14, 114, to facilitate working with sheets of wallpaper P having various widths and/or working in confined spaces. Components of the wallpapering aid 10, 110 may be made of any suitable material, including plastic and aluminium, and by any suitable manufacturing process, including injection and extrusion moulding.

The invention extends to any novel one, or any novel combination, of the features disclosed in this specification (including any accompanying claims and drawings). The claims should not be construed to cover merely the foregoing embodiments, but also any embodiments falling within the scope of the claims. Each feature disclosed in this specification (including any accompanying claims and drawings) may be replaced by alternative features serving the same, equivalent or similar purpose, unless expressly stated otherwise. Thus, unless expressly stated otherwise, each feature disclosed is one example only of a generic series of equivalent or similar features.

All of the features disclosed in this specification (including any accompanying claims and drawings) may be combined in any combination, except combinations where at least some of such features are mutually exclusive. The invention is defined by the appended claims.

1-23. (canceled)

24. A wallpapering aid comprising:
a base having a ground engaging portion; and
a support configured to extend from the base and, in use, bear against a sheet of wallpaper hanging from a height above the support to cause a lower region of the sheet of wallpaper to hang offset horizontally from an upper region of the sheet of wallpaper.

25. A wallpapering aid according to claim 24, further comprising first and second connecting portions cooperable with one another to releasably connect the base and the support to one another.

26. A wallpapering aid according to claim 25, wherein the first and second connecting portions are cooperable with one another such that the support extends from the base selectively in a first configuration, in which the support extends from the base furthest in a first direction, and a second configuration, in which the support extends from the base furthest in a second direction opposite the first direction.

27. A wallpapering aid according to claim 26, wherein the first and second connecting portions are cooperable with one another such that the support extends from the base in the first and second configurations only.

28. A wallpapering aid according to claim 25, wherein the first and second connecting portions are cooperable with one another in that the first connecting portion has a hole and the second connecting portion has a peg receivable in the hole.

29. A wallpapering aid according to claim 28, wherein the hole is an open channel extending through the first connecting portion and the peg is receivable in the channel via an open end thereof such that the peg extends through a mouth of the channel.

30. A wallpapering aid according to claim 29, wherein the channel has a substantially acute trapezoidal cross-section and the mouth of the channel is a shortest side of two parallel sides of the cross-section of the channel.

31. A wall papering aid according to claim 29, wherein the peg has a substantially acute trapezoidal cross-section and is receivable in the channel such that a longest of two parallel sides of the cross-section of the peg is inside the channel and a shorter side of the two parallel sides of the cross-section of the peg is outside the channel.

32. A wallpapering aid according to claim 28, wherein the peg has a plurality of spaced apart peg portions and the first and second connecting portions are cooperable with one another in that one or more of peg portions are receivable in the hole selectively.

33. A wallpapering aid according to claim 28, wherein the peg has rotational symmetry of order two such that the peg is receivable in the hole selectively in a first orientation and a second orientation and the support extends from the base in the first and second configurations, respectively.

34. A wallpapering aid according to claim 33, wherein the peg is receivable in the hole in the first and second orientations only.

35. A wallpapering aid according to claim 25, wherein the first and second connecting portions are cooperable in that together they provide a push fit connection.

36. A wallpapering aid according to claim 25, wherein the base comprises the first connecting portion and the support comprises the second connecting portion.

37. A wallpapering aid according to claim 25, wherein a distance between the ground engaging portion of the base and the support is variable.

38. A wallpapering aid according to claim 37, wherein the base comprises a telescopic portion configured to vary the distance between the ground engaging portion of the base and the support.

39. A wallpapering aid according to claim 24, wherein the support comprises a plurality of spaced apart first projections to, in use, bear against the sheet of wallpaper.

40. A wallpapering aid according to claim 25, wherein the base comprises a plurality of connecting portions according to either of the first and second connecting portions, each of the plurality of connecting portions being configured such that, in use, the support extends from the base selectively at a first height above the ground when connected to one of the plurality of connecting portions and at a second height above the ground, lower than the first height, when connected to another of the plurality of connecting portions.

41. A method of hanging wallpaper comprising:
providing a wallpapering aid adjacent a wall to be wallpapered, the wallpapering aid comprising:
a base having a ground engaging portion; and
a support configured to extend from the base;
fixing an upper edge of a sheet of wallpaper to a wall at a height above the support while the support bears against the sheet of wallpaper to cause a lower region of the sheet of wallpaper to hang offset horizontally from an upper region of the sheet of wallpaper.

42. A method according to claim 41, further comprising releasably connecting the base and the support to one another selectively such that the support extends from the base in a first configuration, in which the support extends from the base furthest in a first direction, and a second configuration, in which the support extends from the base furthest in a second direction opposite the first direction.

43. A method according to claim 41, further comprising providing the wallpapering aid adjacent a wall such the support contacts the wall.
